(19) United States
(12) Patent Application Publication
(10) Pub. No.: US 2024/0188551 A1
(43) Pub. Date: Jun. 13, 2024

(54) SINKER FOR UNDERWATER MOBILE BODY OR SINKER FOR FISHING TACKLE, AND ENTANGLEMENT PREVENTION STRUCTURE OF SINKER FOR UNDERWATER MOBILE BODY OR ENTANGLEMENT PREVENTION STRUCTURE OF SINKER FOR FISHING TACKLE

(71) Applicant: Yasuo KOBAYASHI, Chiba (JP)

(72) Inventor: Yasuo KOBAYASHI, Hunabashi-shi, Chiba (JP)

(21) Appl. No.: 18/553,993

(22) PCT Filed: Apr. 14, 2021
(86) PCT No.: PCT/JP2021/016108

§ 371 Date: Oct. 5, 2023

(51) Int. Cl. A01K 95/00

(52) U.S. Cl. CPC A01K 95/00

(57) ABSTRACT

The present disclosure aims to provide a sinker which keeps a main body of an underwater mobile body or a main body of a fishing tackle at a constant height range from a water bottom regardless of the water depth, wherein a force of pulling the main body downward is adjusted more sharply and/or more quickly in accordance with ups and downs of the water bottom, as well as the sinker snags more hardly on obstacles, and also aims to provide an entanglement prevention structure which prevents the above described type of sinker from getting entangled, as well as which is stowed easily even when mounted. The present disclosure provides a sinker 100 whose mass per unit length varies or a sinker 300 which is configured locally with an 10 unbendable component. In addition, the present disclosure provides a structure 400 of the sinker including a connection portion 400a attached to the main body and an arm portion 400b protruding from the connection portion 400a.

### TECHNICAL FIELD

The present disclosure relates to a sinker for an underwater mobile body to move underwater or a sinker for a fishing tackle to move underwater, and an entanglement prevention structure of the sinker for the underwater mobile body or an entanglement prevention structure of the sinker for the fishing tackle.

### BACKGROUND ART

It is conventionally known that a sinker, which keeps a main body of an underwater mobile body or a main body of a fishing tackle at a constant height range from a water bottom regardless of the water depth, whose main body is a buoyant body configured to go underwater while receiving a resistance of water (shown in Patent document 1). This type of sinker is extended downward from the main body and can be freely curved. A force of pulling the main body downward is adjusted in accordance with an amount of the sinker in contact with the water bottom.

### CITATION LIST

### Patent Literature

[Patent Document 1] Japanese Unexamined Patent Application Publication No. 2019-068780

### SUMMARY

### Technical Problem

However, in the underwater mobile body and the fishing tackle equipped with the sinker of the above described conventional technology, the force of pulling the main body downward is adjusted in accordance with the amount of the sinker in contact with the water bottom while the underwater mobile body or the fishing tackle is moving underwater. Thus, a time lag unavoidably occurs in the vertical movement of the main body with respect to ups and downs (undulations) of the water bottom. Therefore, when ups and downs of the water bottom are fine or when ups and downs of the water bottom are frequent, it is not easy to adjust to move the main body vertically following ups and downs of the water bottom faithfully. In addition, when ups and downs of the water bottom are steep, it is not easy to adjust to keep the main body at a constant height range from the water bottom.

In the above described conventional technology, since the sinker is extended thinly and can be freely curved, the sinker snags on obstacles in some cases although the frequency is reduced compared to techniques before that. Furthermore, the sinker tends to be entangled with the other components. In such a case, it is necessary to restart the operation from the beginning. Thus, extra care is required when the sinker is thrown into the water. However, since the posture of the sinker cannot be operated directly in case of surf casting, lure fishing and the like, the sinker is entangled often and fun of the fishing is spoiled.

In order to solve the problems of the above described conventional technology, the present disclosure provides a sinker which keeps a main body of an underwater mobile body or a main body of a fishing tackle at a constant height range from a water bottom regardless of the water depth, wherein a force of pulling the main body downward is adjusted more sharply and/or more quickly in accordance with ups and downs of the water bottom, and the sinker snags more hardly on obstacles. In addition, the present disclosure provides an entanglement prevention structure which prevents the above described type of sinker from getting entangled and an entanglement prevention structure of the above described type of sinker which is stowed easily even when mounted.

### Solution to Problem

The present disclosure provides a sinker, which is extended downward from a main body of an underwater mobile body or a main body of a fishing tackle and can be freely curved, whose main body is a buoyant body configured to go underwater while receiving a resistance of water, and whose force of pulling the main body downward is adjusted in accordance with an amount of the sinker in contact with a water bottom, wherein a mass per unit length of the sinker varies continuously, intermittently, or locally in the extending direction.

The present disclosure provides a sinker, which is extended downward from a main body of an underwater mobile body or a main body of a fishing tackle and can be freely curved, whose main body is a buoyant body configured to go underwater while receiving a resistance of water, whose force of pulling the main body downward is adjusted in accordance with an amount of the sinker in contact with a water bottom, and which is configured to separate from the water bottom when moving underwater along a flat water bottom within a suitable speed range, wherein a mass per unit length of the sinker varies continuously, intermittently, or locally in the extending direction.

In addition, the present disclosure provides a sinker, which is extended downward from a main body of an underwater mobile body or a main body of a fishing tackle and can be freely curved, whose main body is a buoyant body configured to go underwater while receiving a resistance of water, and whose force of pulling the main body downward is adjusted in accordance with an amount of the sinker in contact with a water bottom, wherein the sinker is locally unbendable.

In addition, the present disclosure provides a sinker, which is extended downward from a main body of an underwater mobile body or a main body of a fishing tackle and can be freely curved, whose main body is a buoyant body configured to go underwater while receiving a resistance of water, whose force of pulling the main body downward is adjusted in accordance with an amount of the sinker in contact with a water bottom, and which is configured to separate from the water bottom when moving underwater along a flat water bottom within a suitable speed range, wherein the sinker is locally unbendable.

Furthermore, the present disclosure provides an entanglement prevention structure configured to be connected to a sinker which is extended downward from a main body of an underwater mobile body or a main body of a fishing tackle and can be freely curved, whose main body is a buoyant body configured to go underwater while receiving a resistance of water, and whose force of pulling the main body downward is adjusted in accordance with an amount of the sinker in contact with a water bottom, wherein the entanglement prevention structure includes: a connection portion attached to the main body of the underwater mobile body or the main body of the fishing tackle; and an arm portion connected to the sinker, the arm portion protruding from the connection portion, and the entanglement prevention structure is configured to keep a distance between the sinker and other components so that the sinker and the other components are not in contact with each other when the sinker is used.

In the above described case, the arm portion can have a flexibility. The arm portion can be attached to the connection portion so as to be invertible with the connection portion. The arm portion can be attached to the connection portion so as to be detachable from the connection portion.

In the above described case, the connection portion can be attached to the main body of the underwater mobile body or the main body of the fishing tackle so as to be detachable from the main body of the underwater mobile body or the main body of the fishing tackle. The connection portion can be formed separately by: a base portion fixed to the main body of the underwater mobile body or the main body of the fishing tackle; and a support portion from which the arm portion is protruded, and the base portion can be attached to the support portion so as to be detachable from the support portion.

Furthermore, the present disclosure provides an entanglement prevention structure configured to be connected to a sinker which is extended downward from a main body of an underwater mobile body or a main body of a fishing tackle and can be freely curved, whose main body is a buoyant body configured to go underwater while receiving a resistance of water, whose force of pulling the main body downward is adjusted in accordance with an amount of the sinker in contact with a water bottom, and which is configured to separate from the water bottom when moving underwater along a flat water bottom within a suitable speed range, wherein the entanglement prevention structure includes: a connection portion attached to the main body of the underwater mobile body or the main body of the fishing tackle; and an arm portion connected to the sinker, the arm portion protruding from the connection portion, and the entanglement prevention structure is configured to keep a distance between the sinker and other components so that the sinker and the other components are not in contact with each other when the sinker is used.

In the above described case, the arm portion can have a flexibility. The arm portion can be attached to the connection portion so as to be invertible with the connection portion. The arm portion can be attached to the connection portion so as to be detachable from the connection portion.

In the above described case, the connection portion can be attached to the main body of the underwater mobile body or the main body of the fishing tackle so as to be detachable from the main body of the underwater mobile body or the main body of the fishing tackle. The connection portion can be formed separately by: a base portion fixed to the main body of the underwater mobile body or the main body of the fishing tackle; and a support portion from which the arm portion is protruded, and the base portion can be attached to the support portion so as to be detachable from the support portion.

### Effects of the Invention

The present disclosure can provide a sinker which keeps a main body of an underwater mobile body or a main body of a fishing tackle at a constant height range from a water bottom regardless of the water depth, wherein a force of pulling the main body downward is adjusted more sharply and/or more quickly in accordance with ups and downs of the water bottom, and the sinker snags more hardly on obstacles. In addition, the present disclosure can provide an entanglement prevention structure which prevents the above described type of sinker from getting entangled and an entanglement prevention structure of the above described type of sinker which is stowed easily even when mounted.

### BRIEF DESCRIPTION OF THE DRAWINGS

FIGS. 1A to 1C are schematic diagrams showing a lure (fishing lure) of an embodiment concerning the conventional technology. FIG. 1A shows a state that the lure moves underwater, FIG. 1B shows a state that the same lure moves upward on a level difference, and

FIG. 1C shows a state immediately after the same lure has finished moving upward on the level difference.

FIGS. 1-1A to 1-1C are schematic diagrams showing a lure of an embodiment concerning the conventional technology. FIG. 1-1A shows a state immediately before the lure same as FIGS. 1A to 1C moves downward over a level difference, FIG. 1-1B shows a state that the same lure moves downward over the level difference, and FIG. 1-1C shows a state that the same lure is landed on a water bottom.

FIGS. 2A to 2C are schematic diagrams showing a lure of an embodiment of the present disclosure where only the sinker coupled to the main body of the lure shown in FIGS. 1A to 1C is replaced with a sinker whose mass per unit length is increased intermittently in the direction extending from the main body. FIG. 2A shows a state that the lure moves underwater, FIG. 2B shows a state that the same lure moves upward on a level difference, and FIG. 2C shows a state immediately after the same lure has finished moving upward on the level difference.

FIGS. 3A to 3C are schematic diagrams showing a lure of an embodiment of the present disclosure where only the sinker coupled to the main body of the lure shown in FIG. 1-1A to 1-1C is replaced with a sinker including a member made of an unbendable material at an end portion. FIG. 3A shows a state immediately before the lure moves downward over a level difference, FIG. 3B shows a state that the same lure moves downward over the level difference, and FIG. 3C shows a state that the same lure is landed on a water bottom.

FIGS. 4A to 4D are schematic diagrams showing a sinker of a variation example of the present disclosure where the sinker for lure having a different shape is shown.

FIGS. 5A and 5B are schematic diagrams showing a state that the lure of the embodiment of the conventional technology and the lure of the embodiment of the present disclosure are casted by using a not illustrated fishing rod (lure rod) provided with a reel around which a fishing line 10 is wound and the lures are flying in the air. FIG. 5A shows a state that the lure of the conventional technology is flying in the air and FIG. 5B shows a state that the lure provided with the entanglement prevention structure of the sinker of the present embodiment between the main body of the lure same as FIG. 5A and the sinker for the lure same as FIG. 5A is flying in the air.

FIG. 6 is a schematic diagram showing the entanglement prevention structure of the embodiment of the present disclosure provided with an arm having a flexibility.

FIG. 7 is a schematic diagram showing the entanglement prevention structure of the sinker for the lure of the embodiment of the present disclosure provided with an arm attached so as to be invertible.

FIG. 8 is a schematic diagram showing the entanglement prevention structure of the sinker for the lure of the embodiment of the present disclosure provided with an arm attached so as to be detachable.

FIG. 9 is a schematic diagram showing the entanglement prevention structure of the sinker for the lure of the embodiment of the present disclosure attached so as to be detachable.

FIG. 10 is a schematic diagram showing the entanglement prevention structure of the sinker for the lure of the embodiment of the present disclosure where the connection portion is formed separately and attached so as to be detachable.

FIGS. 11A to 11C are schematic diagrams showing the entanglement prevention structure of the sinker for the lure concerning the variation example.

### DESCRIPTION OF EMBODIMENTS

Hereafter, the preferable embodiments of the present disclosure will be explained with reference to the drawings.

### Embodiment 1

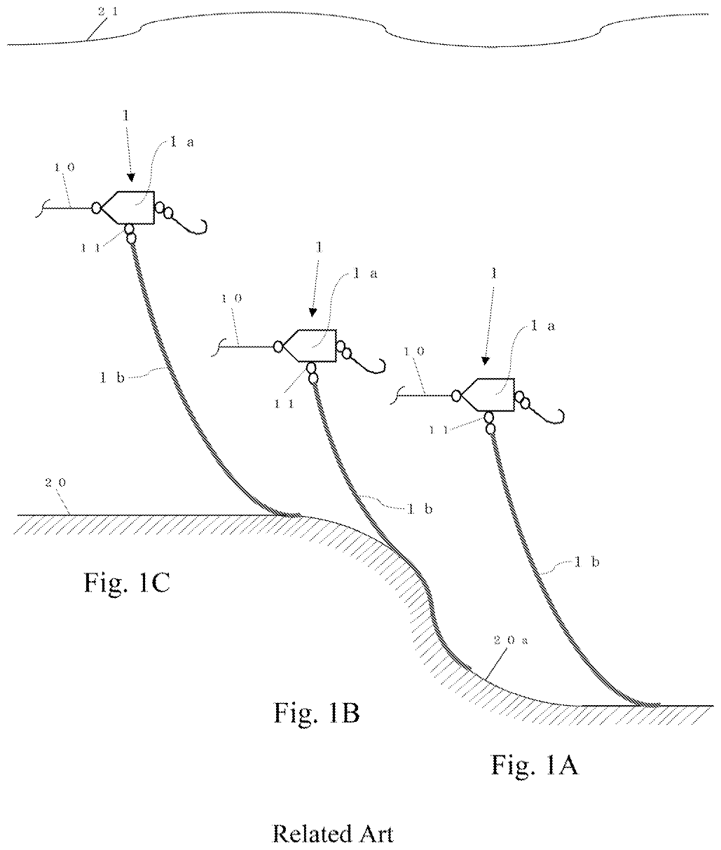

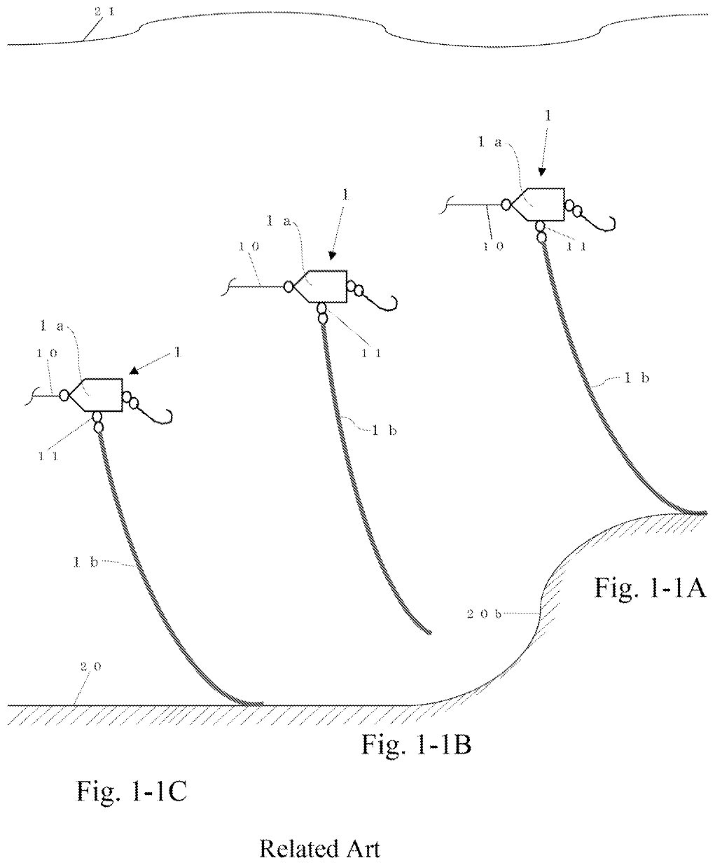

FIGS. 1A to 1C and 1-1A to 1-1C are schematic diagrams showing a lure (fishing lure) of an embodiment concerning the conventional technology. FIG. 1A shows a state that the lure moves underwater, FIG. 1B shows a state that the same lure moves upward on a level difference, and FIG. 1C shows a state immediately after the same lure has finished moving upward on the level difference. FIG. 1-1A shows a state immediately before the lure same as FIGS. 1A to 1C moves downward over a level difference, FIG. 1-1B shows a state that the same lure moves downward over the level difference, and FIG. 1-1C shows a state that the same lure is landed on a water bottom.

Hereafter, an explanation will be made about a sinker 1b of the lure (fishing tackle). A sinker 1b of a lure 1 is coupled to a main body 1a which is a buoyant body configured to go underwater while receiving a resistance of water. The sinker 1b of the lure 1 adjusts a force of pulling the main body 1a downward in accordance with an amount of the sinker 1b in contact with a water bottom to keep the main body 1a at a constant height range from the water bottom regardless of the water depth. The sinker 1b of the lure 1 is extended downward from the main body 1a and can be freely curved. As shown in FIG. 1A, FIG. 1C, FIG. 1-1A, and FIG. 1-1C, the sinker 1b is preliminarily adjusted to move underwater in a state that a certain amount of the sinker 1b is in contact with a water bottom 20 when the main body 1a is pulled approximately horizontally underwater within a suitable speed range by the fishing line 10 along a flat water bottom.

### Embodiment 2

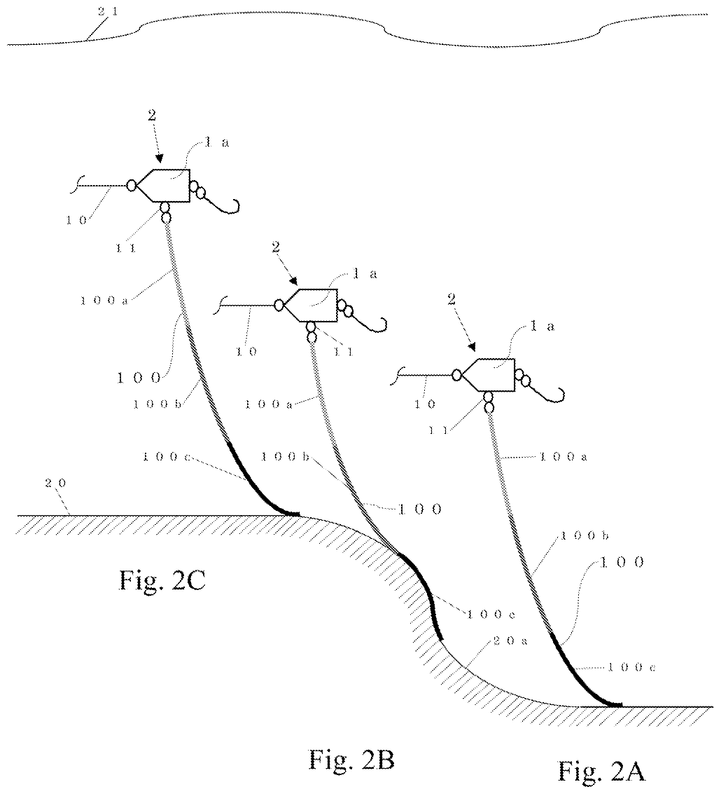

FIGS. 2A to 2C are schematic diagrams showing a lure of an embodiment of the present disclosure where only the sinker coupled to the main body of the lure shown in FIGS. 1A to 1C is replaced with a sinker whose mass per unit length is increased intermittently in the direction extending from the main body. FIG. 2A shows a state that the lure moves underwater, FIG. 2B shows a state that the same lure moves upward on a level difference, and FIG. 2C shows a state immediately after the same lure has finished moving upward on the level difference.

Hereafter, an explanation will be made about a sinker 100 of the lure (fishing tackle). Similar to the sinker 1b of the lure 1 of the conventional technology shown in FIGS. 1A to 1C, a sinker 100 of a lure 2 is coupled to a main body 1a, which is a buoyant body configured to go underwater while receiving a resistance of water. The sinker 100 of the lure 2 is extended downward and can be freely curved. Similar to the sinker 1b of the lure 1, the sinker 100 of the lure 2 is made of materials whose volume are hard to vary due to water pressure. A specific gravity of the sinker 100 is specified to be larger than that of the water body where the lure 2 is used. The sinker 100 of the lure 2 has enough strength not to be broken when the lure 2 is used. It is preferable to use materials as inconspicuous and quiet as possible underwater for the sinker 100. It is also possible to use a material which has an effect of attracting fish or an effect of encouraging predation due to color, luster, light reflection, sound, or the like. A sinker-release device could be provided on a ring 1 where the sinker 100 is coupled to the main body 1a or on an intermediate portion of the sinker 100 so that only the sinker 100 can be cut off and left when the sinker 100 of the lure 2 snags. Here, the sinker 100 to be released is preferably made of a material harmless to the environment.

A thickness (diameter) of a cross-section perpendicular to the extending direction of the sinker 100 of the lure 2 is equal to that of the sinker 1b of the lure 1. The entire length and the entire mass of the sinker 100 of the lure 2 are equal to those of the sinker 1b of the lure 1 also. However, the mass per unit length of the sinker 100 of the lure 2 is increased intermittently in the direction extending from the main body 1a. The mass per unit length of a sinker 100a is less (lighter) than that of the sinker 1b, the mass per unit length of a sinker 100b is equal to that of the sinker 1b, and the mass per unit length of a sinker 100c is more (heavier) than that of the sinker 1b.

Similar to the sinker 1b of the lure 1 shown in FIG. 1A, as shown in FIG. 2A, the sinker 100 of the lure 2 moves underwater in a state that a certain amount of the sinker 100 is in contact with a water bottom 20 when the main body 1a is pulled approximately horizontally underwater by the fishing line 10 along a flat water bottom at a suitable and the same speed as the lure 1. However, since the mass per unit length of the sinker 100c is more (heavier) than that of the sinker 1b, a balance is maintained in a state that the length of the portion of the sinker 100 of the lure 2 in contact with the water bottom is shorter than the length of the portion of the sinker 1b of the lure 1 in contact with the water bottom shown in FIG. 1A.

When the sinker 100 of the lure 2 begins to move upward on a level difference 20a as shown in FIG. 2B, the portion in contact with the water bottom is increased in accordance with the shape of the level difference 20a compared to the time moving on a flat water bottom. At this time, the mass of the sinker 100 of the lure 2 supported by the level difference 20a is increased more rapidly than the mass of the sinker 1b of the lure 1 supported by the level difference 20a shown in FIG. 1B. Thus, a force of pulling the main body 1a downward in accordance with an amount of the sinker 100 of the lure 2 in contact with the water bottom is decreased more rapidly compared to the case of the sinker 1b of the lure 1. Accordingly, the main body 1a of the lure 2 moves upward along the shape of the level difference 20a earlier (i.e., more sharply) than the main body 1a of the lure 1 shown in FIG. 1B. After the sinker 100 of the lure 2 moves upward on the level difference 20a, as shown in FIG. 2C, the sinker 100 of the lure 2 moves on the water bottom 20 in an approximately same state as the state shown in FIG. 2A earlier compared to the case of the sinker 1b of the lure 1 shown in FIG. 1C.

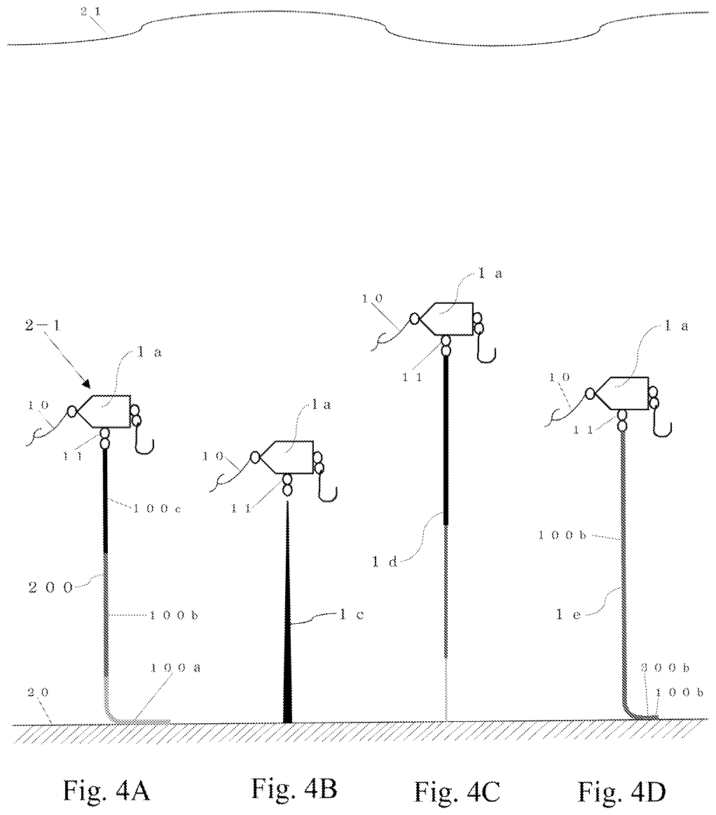

In the present embodiment, the mass per unit length of the sinker 100 is increased intermittently in the direction extending from the main body 1a. However, the sinker is not limited to the above described configuration. As shown in FIG. 4A, it is also possible to configure a sinker 200 of a lure 2-1 by coupling the sinker 100 in opposite direction. Namely, the mass per unit length of the sinker 200 of a lure 2-1 is decreased intermittently in the direction extending from the main body 1a.

In the above described case, a force of pulling the main body 1a downward in accordance with an amount of the sinker 200 of the lure 2-1 in contact with the water bottom is decreased more slowly compared to the case of the sinker 1b of the lure 1 shown in FIG. 1B. Accordingly, the main body 1a of the lure 2-1 moves upward along the shape of the water bottom later (i.e., more slowly) than the main body 1a of the lure 1 shown in FIG. 1B.

### Embodiment 3

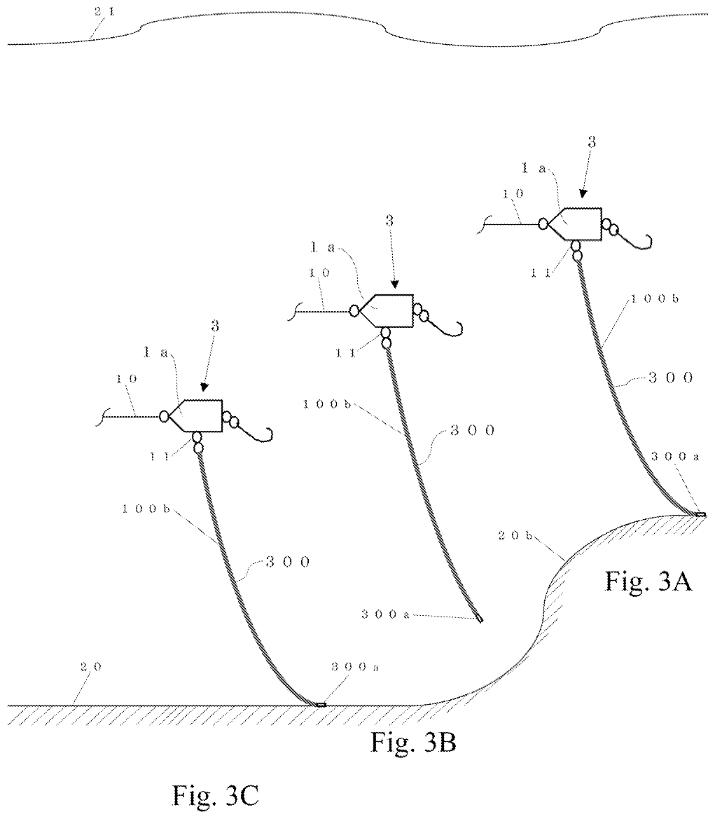

FIGS. 3A to 3C are schematic diagrams showing a lure of an embodiment of the present disclosure where only the sinker coupled to the main body of the lure shown in FIG. 1-1A to 1-1C is replaced with a sinker including a member made of an unbendable material at an end portion. FIG. 3A shows a state immediately before the lure moves downward over a level difference, FIG. 3B shows a state that the same lure moves downward over the level difference, and FIG. 3C shows a state that the same lure is landed on a water bottom.

Hereafter, an explanation will be made about a sinker 300 of the lure (fishing tackle). Similar to the sinker 1b of the lure 1 of the conventional technology shown in FIGS. 1-1A to 1-1C, a sinker 300 of a lure 3 is coupled to a main body 1a, which is a buoyant body configured to go underwater while receiving a resistance of water. The sinker 300 of the lure 3 is extended downward and can be freely curved except for a sinker 300a. Similar to the sinker 1b of the lure 1, the sinker 300 of the lure 3 is made of materials whose volume are hard to vary due to water pressure. A specific gravity of the sinker 300 is specified to be larger than that of the water body where the lure 3 is used. The sinker 300 of the lure 3 has enough strength not to be broken when the lure 3 is used. It is preferable to use materials as inconspicuous and quiet as possible underwater for the sinker 300. It is also possible to use a material which has an effect of attracting fish or an effect of encouraging predation due to color, luster, light reflection, sound, or the like. A sinker-release device could be provided on a ring 1 where the sinker 300 is coupled to the main body 1a or on an intermediate portion of the sinker 300 so that only the sinker 300 can be cut off and left when the sinker 300 of the lure 3 snags. Here, the sinker 300 to be released is preferably made of a material harmless to the environment.

The entire mass of the sinker 300 of the lure 3 is equal to that of the sinker 1b of the lure 1. The sinker 300 of the lure 3 is configured with the sinker 100b, whose mass per unit length is equal to that of the sinker 1b of the lure 1 and whose thickness (diameter) of the cross-section perpendicular to the extending direction is equal to that of the sinker 1b of the lure 1, except for the sinker 300a located at an end portion of the sinker 300. In addition, the sinker 300a made of an unbendable material is used at an end portion of the sinker 300 of the lure 3. The mass per unit length of the sinker 300a in the extending direction is more (heavier) than that of the sinker 1b. The thickness (diameter) of the cross-section perpendicular to the extending direction of the sinker 300a is equal to that of the sinker 1b.

Accordingly, although the entire mass of the sinker 300 of the lure 3 is equal to that of the sinker 1b of the lure 1, the entire length of the sinker 300 of the lure 3 is necessarily shorter than that of the sinker 1b of the lure 1 since the sinker 300 is configured with combining the sinker 100b whose mass per unit length is equal to that of the sinker 1b and the sinker 300a whose mass per unit length is more (heavier) than that of the sinker 1b.

Similar to the sinker 1b of the lure 1 shown in FIG. 1-1A, as shown in FIG. 3A, the sinker 300 of the lure 3 moves underwater in a state that a certain amount of the sinker 300 is in contact with the water bottom 20 when the main body 1a is pulled approximately horizontally underwater by the fishing line 10 along a flat water bottom at a suitable and the same speed as the lure 1. However, since the mass per unit length of the sinker 300a is more (heavier) than that of the sinker 1b, a balance is maintained in a state that the length of the portion of the sinker 300 of the lure 3 in contact with the water bottom is shorter than the length of the portion of the sinker 1b of the lure 1 in contact with the water bottom shown in FIGS. 1-1A.

Note that if the sinker 100b of the sinker 300 of the lure 3 is in a linear state without being curved at this time, the function, which is inherent in this type of sinker, of adjusting the force of pulling the main body downward in accordance with the amount of the sinker in contact with the water bottom may deteriorate. Therefore, the sinker 100b is preliminarily adjusted to keep its state curved when the main body 1a of the lure 3 is pulled approximately horizontally underwater by the fishing line 10 within a suitable speed range.

After the sinker 300 of the lure 3 reaches a level difference 20b as shown in FIG. 3B, the portion in contact with the water bottom is separated from the water bottom 20 earlier compared to the case of the sinker 1b of the lure 1 since the entire length of the sinker 300 of the lure 3 is shorter than that of the sinker 1b of the lure 1. At this time, the force of pulling the main body 1a downward is increased more rapidly compared to the case of the sinker 1b of the lure 1. Thus, the main body 1a of the lure 3 starts descending earlier (i.e., more sharply) than the main body 1a of the lure 1 shown in FIG. 1-1B.

In addition, the resistance of water received by the sinker 300 of the lure 3 is smaller than that of the sinker 1b of the lure 1 since the entire length is shorter. Accordingly, the lure 3 descends faster (i.e., more quickly) than the lure 1. After the sinker 300 of the lure 3 moves downward over the level difference 20b and lands on the water bottom, as shown in FIG. 3C, the sinker 300 of the lure 3 moves on the water bottom 20 in an approximately same state as the state shown in FIG. 3A earlier compared to the case of the sinker 1b of the lure 1 shown in FIG. 1-1C.

In the sinker 100 of the lure of the present embodiment, the force of pulling the main body 1a of the lure downward in accordance with ups and downs of the water bottom can be adjusted more sharply compared to the conventional technology. In addition, in the sinker 300 of the lure of the present embodiment, the force of pulling the main body 1a of the lure downward in accordance with ups and downs of the water bottom can be adjusted more sharply compared to the conventional technology, and it is possible to make the lure descend more quickly compared to the conventional technology. Furthermore, in both the sinker 100 of the lure and the sinker 300 of the lure, it is possible to make the lure snag on obstacles more hardly since the length of the portion in contact with the water bottom is shorter compared to the sinker 1b which is the conventional technology. In addition, in the sinker 200 of the lure of the present embodiment, the force of pulling the main body 1a of the lure downward in accordance with ups and downs of the water bottom can be adjusted more slowly compared to the conventional technology.

### Embodiment 4

Although the present disclosure is explained based on above embodiments, the present disclosure is not limited to the above described configurations. Although the present disclosure is explained by using the sinker 100, the sinker 200, and the sinker 300 of the lure as sinker for fishing tackle in the above embodiments, the present disclosure is not limited to the above described configurations.

For example, the following configurations can be also adopted. As shown in FIG. 4B, a sinker 1c, which is coupled to and extended downward from the main body 1a that is a buoyant body configured to go underwater while receiving a resistance of water, whose mass per unit length and whose thickness (diameter) of the cross-section perpendicular to the extending direction are increased continuously in the direction extending from the main body 1a, and whose force of pulling the main body 1a downward is adjusted in accordance with an amount of the sinker 1c in contact with the water bottom, is configured to separate from the water bottom when moving underwater along a flat water bottom within a suitable speed range. As shown in FIG. 4C, a sinker 1d, whose mass per unit length and whose thickness (diameter) of the cross-section perpendicular to the extending direction are decreased intermittently in the direction extending from the main body 1a, is configured to separate from the water bottom when moving underwater along a flat water bottom just at a very slow speed. As shown in FIG. 4D, a sinker 1e is configured locally (at least partly) with a sinker 300b, which is made of an unbendable material, whose mass per unit length is increased locally, and whose thickness (diameter) of the cross-section perpendicular to the extending direction is thin locally.

### Embodiment 5

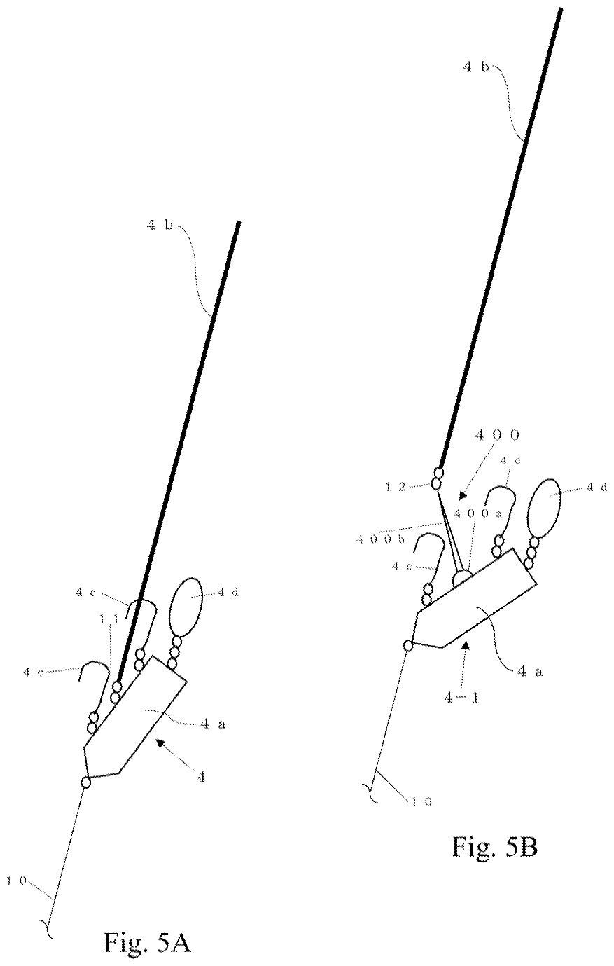

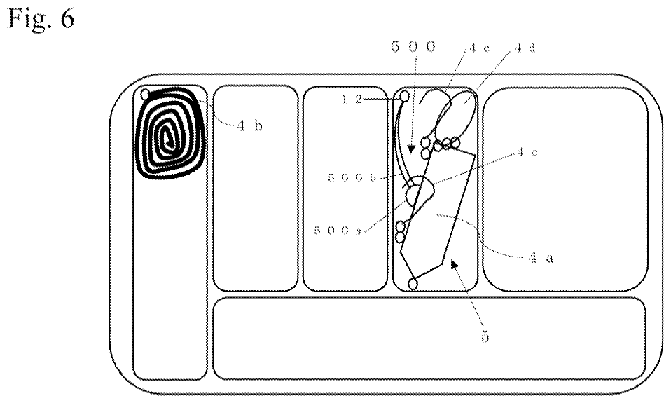

FIGS. 5A and 5B are schematic diagrams showing a state that the lure of the embodiment of the conventional technology and the lure of the embodiment of the present disclosure are casted by using a not illustrated fishing rod (lure rod) provided with a reel around which a fishing line 10 is wound and the lures are flying in the air. FIG. 5A shows a state that the lure of the conventional technology is flying in the air and FIG. 5B shows a state that the lure provided with the entanglement prevention structure of the sinker of the present embodiment between the main body of the lure same as FIG. 5A and the sinker for the lure same as FIG. 5A is flying in the air. Hereafter, an explanation will be made about an entanglement prevention structure 400 of the sinker for the lure (fishing tackle). As shown in FIG. 5B, the entanglement prevention structure 400 of the sinker for a lure 4-1 includes a connection portion 400a attached to a main body 4a which is a buoyant body configured to go underwater while receiving a resistance of water and an arm portion 400b protruded from the connection portion 400a and connected to a sinker 4b which is extended so as to be freely curved. In addition, the entanglement prevention structure 400 of the sinker has enough strength and durability not to be bent, separated or broken when it is used. It is preferable to use a material as inconspicuous, quiet and harmless to the environment as possible underwater. The connection portion 400a is installed on the main body 4a of the lure 4-1 to function as a base for supporting the arm portion 400b and enhancing the strength and the durability of the arm portion 400b which is protruded from the connection portion 400a. The connection portion 400a of the entanglement prevention structure 400 of the sinker has an installation surface. The connection portion 400a is attached to the main body 4a so that the installation surface of the connection portion 400a is in contact with the surface of the main body 4a of the lure 4-1. The method of attaching the connection portion 400a to the main body 4a is not limited. For example, screw clamp, adhesion, welding or an eyelet preliminarily provided on the main body 4a of the lure 4-1 can be used (i.e., utilizing a shape of the main body of the lure). Furthermore, it is also possible to integrally form the connection portion 400a with the main body 4a of the lure 4-1 when the main body 4a is formed. In any cases, it is enough if the connection portion 400a is fixed to the main body 4a with enough strength and durability to withstand use not to be separated from the main body 4a and not to be broken. The arm portion 400b is a component for keeping an interval between the sinker 4b of the lure 4-1 and a fishing hook 4c and an interval between the sinker 4b of the lure 4-1 and a spinner blade 4d. The arm portion 400b of the entanglement prevention structure 400 of the sinker is protruded from the connection portion 400a. The arm portion 400b is connected to the sinker 4b by a ring 2 which is an eyelet provided near the end portion of the arm portion 400b. A so-called snap or a split ring can be used for connecting the ring 2 and the sinker 4b so that the sinker 4b can be detached and replaced easily. In addition, a sinker-release device can be provided on the ring 2 so that only the sinker 4b can be separated and detached when the sinker 4b snags. The air resistance of the arm portion 400b of the entanglement prevention structure 400 of the sinker is reduced as the cross-sectional area perpendicular to the extending direction of the arm portion 400b becomes smaller. Thus, the influence affected to the flying action of the lure 4-1 in the air can be reduced by reducing the cross-sectional area. The water resistance when pulled by the fishing line 10 is also reduced as the cross-sectional area becomes smaller. Thus, the influence affected to the action of the main body 4a in the water can be reduced by reducing the cross-sectional area. When a lure 4 is casted in the air, as shown in FIG. 5A, the lure 4 flies in the air in a state that the sinker 4b is in the most advanced position since the specific gravity of the sinker 4b is larger and the air resistance is smaller compared to the main body 4a and the mass of the sinker 4b is heavier compared to the fishing hook 4c and the spinner blade 4d. Furthermore, the lure 4 flies in the air in a state that the end portion of the sinker 4b is in the most advanced position since the sinker 4b is extended thinly and freely curved. However, the state of the lure 4 during the flying action varies depending on various elements constituting the lure 4 such as the mass, the shape and the balance of each of the main body 4a, the sinker 4b, the fishing hook 4c and the spinner blade 4d and depending on various external factors such as the wind direction, the wind speed and the discharging angle when casting the lure 4 and the rotating motion of the lure 4 itself added when casting the lure 4. Furthermore, the state of the lure 4 varies even when the lure 4 is flying. Accordingly, even when the sinker 4b, the fishing hook 4c and the spinner blade 4d are attached to the main body 4a so that they are separated from each other at an interval required for preventing the contact in the water, they are contacted with each other during the flying or when landing on water and entangled with each other when descending in the water in many cases. However, in the lure 4-1 of the present embodiment, the arm portion 400b is provided to have a length required for keeping the interval between the sinker 4b and the fishing hook 4c and the interval between the sinker 4b and the spinner blade 4d so that they are not contacted with each other regardless of the flying condition of the lure 4-1 in the air and regardless of the condition of landing on the water. Thus, the entanglement of the sinker 4b can be prevented.

### Embodiment 6

FIG. 6 is a schematic diagram showing the entanglement prevention structure of the embodiment of the present disclosure provided with an arm having a flexibility. Hereafter, an explanation will be made about an entanglement prevention structure 500 of the sinker for the lure (fishing tackle). The entanglement prevention structure 500 of the sinker for a lure 5 includes a connection portion 500a attached to the main body 4a which is a buoyant body configured to go underwater while receiving a resistance of water and an arm portion 500b protruded from the connection portion 500a and connected to the sinker 4b which is extended so as to be freely curved. In addition to the configurations already explained in the entanglement prevention structure 400 of the sinker for the lure 4-1, the arm portion 500b of the entanglement prevention structure 500 of the sinker has a flexibility so that the arm portion 500b can be easily bent by fingers to a degree of not reducing the effect of the entanglement prevention structure of the sinker. Consequently, the effect of the entanglement prevention structure is equal to the effect of the sinker for the lure 4-1 during use while the lure 5 can be housed compactly in a partition of a fishing tool box or the like as shown in FIG. 6 similar to the lure 4 which is not provided with the entanglement prevention structure of the sinker to avoid the situation of requiring large space due to the projection of the arm portion 500b compared to the lure having the approximately same size.

### Embodiment 7

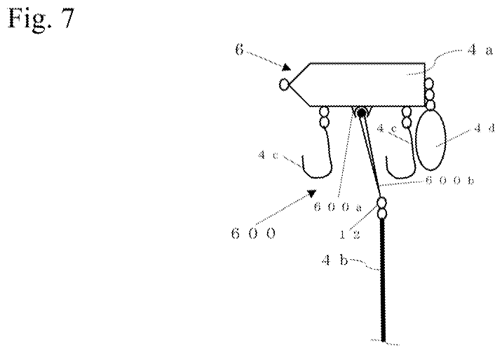

FIG. 7 is a schematic diagram showing the entanglement prevention structure of the sinker for the lure of the embodiment of the present disclosure provided with an arm attached so as to be invertible. Hereafter, an explanation will be made about an entanglement prevention structure 600 of the sinker for the lure (fishing tackle). The entanglement prevention structure 600 of the sinker for a lure 6 includes a connection portion 600a attached to the main body 4a which is a buoyant body configured to go underwater while receiving a resistance of water and an arm portion 600b protruded from the connection portion 600a and connected to the sinker 4b which is extended so as to be freely curved. In addition to the configurations already explained in the entanglement prevention structure 400 of the sinker for the lure 4-1, the arm portion 600b of the entanglement prevention structure 600 of the sinker is attached to the connection portion 600a so as to be tiltable around the connection portion 600a. The arm portion 600b is attached to the connection portion 600a by using a ball joint, a hinge, or the like as shown in FIG. 7. Furthermore, the method of attaching the arm portion 600b to the connection portion 600a is not limited. For example, an eyelet preliminarily provided on the main body 4a of the lure 6 can be used (i.e., utilizing a shape of the main body of the lure) without limited to the connection portion 600a and the arm portion 600b. In any cases, it is enough if the arm portion 600b is fixed to the connection portion 600a with enough strength and durability to withstand use not to be separated from the connection portion 600a and not to be broken. The arm portion 600b can have a restoration property in the direction of protruding the arm portion 600b in addition to the tiltable property. For example, it is possible to provide an elastic body such as a spring and a rubber so that the direction of protruding the arm portion 600b becomes constant with respect to the surface of installing the connection portion 600a when the load of the connected sinker is within a predetermined range. For example, it is possible to provide the arm portion 600b so as to be tiltable toward the main body 4a so that the arm portion 600b does not obstruct the predation of the lure 6 by fishes when there is no load of the sinker. Furthermore, it is also possible to restrict the movable range of the arm portion 600b within a predetermined range if necessary. It is also possible to provide a fastener for temporarily fixing the direction of protruding the arm portion 600b. Consequently, the effect of the entanglement prevention structure is equal to the effect of the sinker for the lure 4-1 during use while the lure 6 can be housed compactly in a partition of a fishing tool box or the like similar to the lure 4 which is not provided with the entanglement prevention structure of the sinker to avoid the situation of requiring large space due to the projection of the arm portion 600b compared to the lure having the approximately same size.

### Embodiment 8

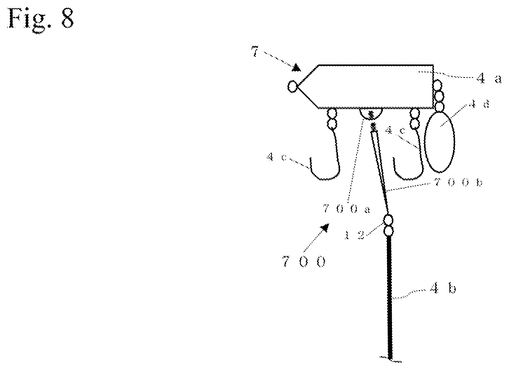

FIG. 8 is a schematic diagram showing the entanglement prevention structure of the sinker for the lure of the embodiment of the present disclosure provided with an arm attached so as to be detachable. Hereafter, an explanation will be made about an entanglement prevention structure 700 of the sinker for the lure (fishing tackle). The entanglement prevention structure 700 of the sinker for a lure 7 includes a connection portion 700a attached to the main body 4a which is a buoyant body configured to go underwater while receiving a resistance of water and an arm portion 700b protruded from the connection portion 700a and connected to the sinker 4b which is extended so as to be freely curved. In addition to the configurations already explained in the entanglement prevention structure 400 of the sinker for the lure 4-1, in the entanglement prevention structure 700 of the sinker, the arm portion 700b is attached to the connection portion 700a so that the arm portion 700b can be detached from the connection portion 700a easily only by fingers or easily by using a simple tool any number of times. The arm portion 700b can be attached to the connection portion 700a by forming a screw shaft on a rear end of the arm portion 700b and forming a screw hole on the connection portion 700a so that screw shaft is screwed in the screw hole as shown in FIG. 8, for example. Alternatively, an eyelet preliminarily provided on the main body 4a of the lure 7 can be used (i.e., utilizing a shape of the main body of the lure) without limited to the connection portion 700a and the arm portion 700b. In any cases, it is enough if the arm portion 700b is fixed to the connection portion 700a with enough strength and durability to withstand use not to be separated from the connection portion 700a and not to be broken. Consequently, the effect of the entanglement prevention structure is equal to the effect of the sinker for the lure 4-1 during use while the arm portion 700b can be detached when housed in a partition of a fishing tool box or the like similar to the lure 4 which is not provided with the entanglement prevention structure of the sinker to avoid the situation of requiring large space compared to the lure having the approximately same size.

### Embodiment 9

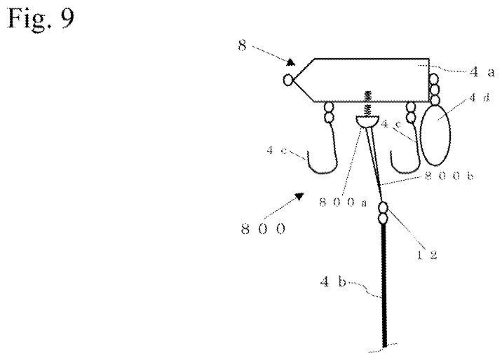

FIG. 9 is a schematic diagram showing the entanglement prevention structure of the sinker for the lure of the embodiment of the present disclosure attached so as to be detachable. Hereafter, an explanation will be made about an entanglement prevention structure 800 of the sinker for the lure (fishing tackle). The entanglement prevention structure 800 of the sinker for a lure 8 includes a connection portion 800a attached to the main body 4a which is a buoyant body configured to go underwater while receiving a resistance of water and an arm portion 800b protruded from the connection portion 800a and connected to the sinker 4b which is extended so as to be freely curved. The entanglement prevention structure 800 of the sinker has the same configurations already explained in the entanglement prevention structure 400 of the sinker for the lure 4-1 except for that the entanglement prevention structure 800 can be freely detachable from the main body 4a of the lure 8. In the entanglement prevention structure 800 of the sinker for the lure 8, different from the entanglement prevention structure 400 of the sinker for the lure 4-1, the surface of installing the connection portion 800a attached to the main body 4a of the lure 8 is not fixed to the main body 4a of the lure 8. Thus, the entanglement prevention structure 400 can be detached from the main body 4a of the lure 8 easily only by fingers or easily by using a simple tool any number of times. The connection portion 800a can be attached to the main body 4a of the lure 8 by forming a screw shaft on the installation surface of the connection portion 800a and forming a screw hole on the main body 4a of the lure 8 so that screw shaft is screwed in the screw hole as shown in FIG. 9, for example. The method of attaching the connection portion 600a to the arm portion 800a is not limited. For example, an eyelet preliminarily provided on the main body 4a of the lure 8 can be used (i.e., utilizing a shape of the main body of the lure). In any cases, it is enough if the connection portion 800a is fixed to the main body 4a of the lure 8 with enough strength and durability to withstand use not to be separated from the main body 4a of the lure 8 and not to be broken. Consequently, the effect of the entanglement prevention structure is equal to the effect of the sinker for the lure 4-1 during use while the entanglement prevention structure 800 can be detached when housed in a partition of a fishing tool box or the like similar to the lure 4 which is not provided with the entanglement prevention structure of the sinker to avoid the situation of requiring large space compared to the lure having the approximately same size.

### Embodiment 10

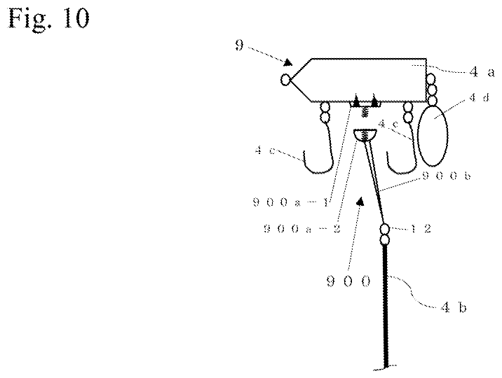

FIG. 10 is a schematic diagram showing the entanglement prevention structure of the sinker for the lure of the embodiment of the present disclosure where the connection portion is formed separately and attached so as to be detachable. Hereafter, an explanation will be made about an entanglement prevention structure 900 of the sinker for the lure (fishing tackle). The entanglement prevention structure 900 of the sinker for a lure 9 includes a connection portion 900a attached to the main body 4a which is a buoyant body configured to go underwater while receiving a resistance of water and an arm portion 900b protruded from the connection portion 900a and connected to the sinker 4b which is extended so as to be freely curved. In the entanglement prevention structure 900 of the sinker, the connection portion 900a is separated into a base portion 900a-1 and a support portion 900a-2. The base portion 900a-1 and the support portion 900a-2 are formed separately from each other and the base portion 900a-1 and the support portion 900a-2 are detachably attached to each other. Except for the above described configuration, the entanglement prevention structure 900 has the same configurations already explained in the entanglement prevention structure 400 of the sinker for the lure. In the connection portion 900a of the entanglement prevention structure 900 of the sinker for the lure 9, different from the connection portion 400a of the entanglement prevention structure 400 of the sinker for the lure 4-1, the connection portion 900a is separated into the base portion 900a-1 fixed to the main body 4a of the lure 9 and the support portion 900a-2 from which the arm portion 900b is protruded. In addition, the base portion 900a-1 and the support portion 900a-2 are formed separately from each other. Furthermore, the support portion 900a-2 is not fixed to the base portion 900a-1. Thus, the support portion 900a-2 is attached to the base portion 900a-1 so that the support portion 900a-2 can be detached from the base portion 900a-1 easily only by fingers or easily by using a simple tool any number of times. The method of attaching the base portion 900a-1 to the main body 4a of the lure 9 is not limited. For example, screw clamp, adhesion, welding or an eyelet preliminarily provided on the main body 4a of the lure 4-1 can be used (i.e., utilizing a shape of the main body of the lure). Furthermore, it is also possible to integrally form the base portion 900a-1 with the main body 4a of the lure 4-1 when the main body 4a is formed. In any cases, it is enough if the base portion 900a-1 is fixed to the main body 4a of the lure 9 with enough strength and durability to withstand use not to be separated from the main body 4a of the lure 9 and not to be broken. The base portion 900a-1 and the support portion 900a-2 can be attached to each other by forming a screw shaft on the connection surface of the base portion 900a-1 and forming a screw hole on the support portion 900a-2 so that screw shaft is screwed in the screw hole as shown in FIG. 10, for example. The method of attaching the support portion 900a-2 to the base portion 900a-1 is not limited. For example, an eyelet preliminarily provided on not only the base portion 900a-1 and the support portion 900a-2 but also the main body 4a of the lure 9 can be used (i.e., utilizing a shape of the main body of the lure). In any cases, it is enough if the support portion 900a-2 is fixed to the base portion 900a-1 with enough strength and durability to withstand use not to be separated from the base portion 900a-1 and not to be broken. Consequently, the effect of the entanglement prevention structure is equal to the effect of the sinker for the lure 4-1 during use while the tip side of the support portion 900a-2 can be detached when housed in a partition of a fishing tool box or the like similar to the lure 4 which is not provided with the entanglement prevention structure of the sinker to avoid the situation of requiring large space compared to the lure having the approximately same size. The entanglement prevention structures 400, 500, 600, 700, 800 and 900 of the sinker for the lure (fishing tackle) of the present embodiment includes the connection portions 400a, 500a, 600a, 700a, 800a, 900a attached to the main body 4a of the lure and the arm portions 400b, 500b, 600b, 700b, 800b, 900b protruded from the connection portions 400a, 500a, 600a, 700a, 800a, 900a and connected to the sinker 4b of the lure. Consequently, a distance can be kept between the sinker 4b and other components so that the sinker 4b and the other components are not in contact with each other when the sinker 4b is thrown in the water. When the sinker 4b is housed, the entanglement prevention structure 400 of the sinker is detached and the sinker 4b can be housed compactly similar to the lure which is not provided with the entanglement prevention structure of the sinker for the present embodiment.

### Embodiment 11

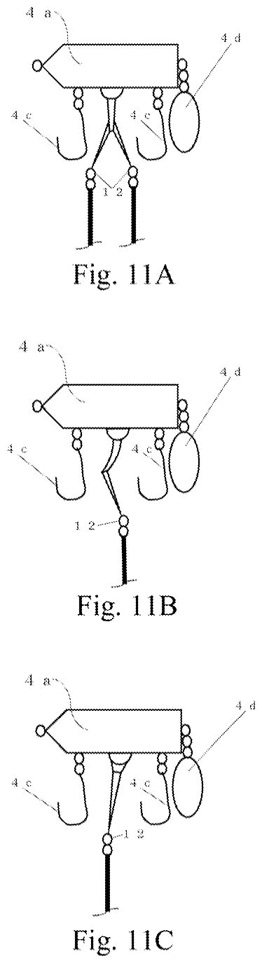

The present disclosure is explained above based on several embodiments. However, the present disclosure is not limited to the above described embodiments. In the above described embodiments, the present disclosure is explained using the entanglement prevention structures 400, 500, 600, 700, 800 and 900 of the sinker for the lure (fishing tackle) as the entanglement prevention structure of the sinker for the fishing tackle. However, the present disclosure is not limited to the above described embodiments. For example, the arm portion can be branched as shown in FIG. 11A, a plurality of arm portions can be provided, the arm portion can be formed in a curved shape or a polygonal line shape as shown in FIG. 11B, or the arm portion can be formed to protrude gently as shown in FIG. 11C.

### INDUSTRIAL APPLICABILITY

The present disclosure can be applied to a sinker for an underwater mobile body having any purposes, a sinker for a fishing tackle having any purposes, an entanglement prevention structure of the underwater mobile body having any purposes, and an entanglement prevention structure of the fishing tackle having any purposes, where the sinker is extended downward from a main body of the underwater mobile body or a main body of the fishing tackle which is a buoyant body configured to go underwater while receiving a resistance of water, and whose force of pulling the main body downward is adjusted in accordance with an amount in contact with a water bottom, as long as the operation and effect of the present disclosure can be obtained.

### REFERENCE SIGNS LIST

1: lure (fishing tackle); la: main body of lure; 1b to 1e: sinker for lure; 2: lure (fishing tackle); 2-1: lure (fishing tackle); 3: lure (fishing tackle); 4: lure (fishing tackle); 4-1: lure (fishing tackle); 4a: main body of lure; 4b: sinker for lure; 4c: fishing hook; 4d: spinner blade; 5: lure (fishing tackle); 6: lure (fishing tackle); 7: lure (fishing tackle); 8: lure (fishing tackle); 9: lure (fishing tackle); 10: fishing line; 11: ring 1; 12: ring 2; 20: water bottom; 20a: level difference (upward); 20b: level difference (downward); 21: water surface; 100: sinker for lure; 100a: member of sinker 100 for lure or sinker 200 for lure where mass per unit length is less (lighter) than that of sinker 1b of lure 1; 100b: member of sinker 100 for lure, sinker 200 for lure, sinker 300 for lure, or sinker 1e for lure where mass per unit length is equal to that of sinker 1b of lure 1; 100c: member of sinker 100 for lure or sinker 200 for lure where mass per unit length is more (heavier) than that of sinker 1b of lure 1; 200: sinker for lure; 300: sinker for lure; 300a: member of sinker 300 for lure using unbendable material where mass per unit length is more (heavier) than that of sinker 1b of lure 1 and thickness (diameter) of cross-section perpendicular is equal to that of sinker 1b of lure 1; 300b: member of sinker 1e for lure using unbendable material where mass per unit length is more (heavier) than that of sinker 1b of lure 1 and thickness (diameter) of cross-section perpendicular is thinner than that of sinker 1b of lure 1; 400: entanglement prevention structure of sinker for lure; 400a: connection portion of entanglement prevention structure of sinker for lure 400; 400b: arm portion of entanglement prevention structure 400 of sinker for lure; 500: entanglement prevention structure of sinker for lure; 500a: connection portion of entanglement prevention structure of sinker for lure 500; 500b: arm portion of entanglement prevention structure 500 of sinker for lure; 600: entanglement prevention structure of sinker for lure; 600a: connection portion of entanglement prevention structure of sinker for lure 600; 600b: arm portion of entanglement prevention structure 600 of sinker for lure; 700: entanglement prevention structure of sinker for lure; 700a: connection portion of entanglement prevention structure of sinker for lure 700; 700b: arm portion of entanglement prevention structure 700 of sinker for lure; 800: entanglement prevention structure of sinker for lure; 800a: connection portion of entanglement prevention structure of sinker for lure 800; 800b: arm portion of entanglement prevention structure 800 of sinker for lure; 900: entanglement prevention structure of sinker for lure; 900a: connection portion of entanglement prevention structure of sinker for lure 900; 900a-1: base portion of connection portion of entanglement prevention structure 900 of sinker for lure attached to main body 4a of lure; 900a-2: support portion of connection portion of entanglement prevention structure 900 of sinker for lure where arm portion 900b is protruded; 900b: arm portion of entanglement prevention structure 900 of sinker for lure

1. A sinker, which is extended downward from a main body of an underwater mobile body or a main body of a fishing tackle and can be freely curved, whose main body is a buoyant body configured to go underwater while receiving a resistance of water, and whose force of pulling the main body downward is adjusted in accordance with an amount of the sinker in contact with a water bottom, wherein
a mass per unit length of the sinker varies continuously, intermittently, or locally in the extending direction,
excluding a component for coupling the sinker to the main body of the underwater mobile body or the main body of the fishing tackle, a single type of chain including a ball shape whose mass per unit length varies repeatedly in a uniform manner in the extending direction, a sinker-release device coupled on both its upper and lower sides to cut off and leave the sinker when the sinker snags components for coupling the sinker-release device to the sinker or the main body, a fish attractor attached from its upper end to its lower end to the sinker, and a component for attaching the fish attractor to the sinker.

2. A sinker, which is extended downward from a main body of an underwater mobile body or a main body of a fishing tackle and can be freely curved, whose main body is a buoyant body configured to go underwater while receiving a resistance of water, whose force of pulling the main body downward is adjusted in accordance with an amount of the sinker in contact with a water bottom, and which is configured to separate from the water bottom when moving underwater along a flat water bottom within a suitable speed range, wherein a mass per unit length of the sinker varies continuously, intermittently, or locally in the extending direction,
excluding a component for coupling the sinker to the main body of the underwater mobile body or the main body of the fishing tackle, a single type of chain including a ball shape whose mass per unit length varies repeatedly in a uniform manner in the extending direction, a sinker-release device coupled on both its upper and lower sides to cut off and leave the sinker when the sinker snags, components for coupling the sinker-release device to the sinker or the main body, a fish attractor attached from its upper end to its lower end to the sinker, and a component for attaching the fish attractor to the sinker.

3-11. (canceled)

12. The sinker according to claim 1, wherein
the sinker is configured locally with an unbendable component.

13. The sinker according to claim 2, wherein
the sinker is configured locally with an unbendable component.
